(19) United States
(12) Patent Application Publication
(10) Pub. No.: US 2021/0039440 A1
(43) Pub. Date: Feb. 11, 2021

(54) PNEUMATIC TIRE

(71) Applicant: Toyo Tire Corporation, Itami-shi (JP)

(72) Inventor: Tetsuji Miyazaki, Itami-shi (JP)

(73) Assignee: Toyo Tire Corporation, Itami-shi (JP)

(21) Appl. No.: 16/934,431

(22) Filed: Jul. 21, 2020

(30) Foreign Application Priority Data
Aug. 7, 2019 (JP) 2019-145299

(51) Int. Cl. B60C 11/03

(52) U.S. Cl. CPC B60C 11/0304; B60C 2011/0372; B60C 2011/0341

(57) ABSTRACT

In a pneumatic tire, at least one annular groove comprises a plurality of groove segments that cause the at least one annular groove to be of polygonal and annular shape, the plurality of groove segments includes at least one shortest groove segment for which length is smallest among the plurality of groove segments, and at least one longest groove segment for which length is largest among the plurality of groove segments, and the length of the shortest groove segment is not less than 40% of the length of the longest groove segment.

### CROSS REFERENCE TO RELATED APPLICATIONS

This application claims the benefit of priority of Japanese application no. 2019-145299, filed on Aug. 7, 2019, which is incorporated herein by reference.

### BACKGROUND OF THE INVENTION

### Field of the Invention

The present disclosure relates to a pneumatic tire.

### Description of the Related Art

Conventionally a pneumatic tire might, for example, comprise a pair of main grooves arranged so as to straddle the tire equatorial plane, and center land portion(s) partitioned by the pair of main grooves (e.g., JP2016-124504A). In addition, center land portion(s) might comprise annular groove(s) arranged in such fashion as to be separated in the tire width direction from main groove(s). But to improve tire performance on snowy road surfaces and adverse road surfaces (especially in muddy terrain), it is necessary to adequately cause functionality of edge components attributable to annular groove(s) to be made manifest.

The problem is therefore to provide a pneumatic tire that makes it possible to adequately cause functionality of edge components attributable to annular groove(s) to be made manifest.

### SUMMARY OF THE INVENTION

There is provided a pneumatic tire comprises:

first and second main grooves extending in a tire circumferential direction and arranged so as to straddle a tire equatorial plane, and a center land portion partitioned by the first and second main grooves;

wherein the center land portion comprises at least one annular groove arranged so as to be separated in a tire width direction from the first and second main grooves and so as to intersect the tire equatorial plane;

wherein the at least one annular groove comprises a plurality of groove segments that cause the at least one annular groove to be of polygonal and annular shape;

wherein the plurality of groove segments includes at least one shortest groove segment for which length is smallest among the plurality of groove segments, and at least one longest groove segment for which length is largest among the plurality of groove segments; and

wherein the length of the shortest groove segment is not less than 40% of the length of the longest groove segment.

Further, the pneumatic tire may have a configuration in which:

wherein the center land portion comprises at least one width connecting groove that causes the at least one annular groove and the first main groove to be connected; and

depth of the at least one annular groove is greater than depth of the at least one width connecting groove.

Further, the pneumatic tire may have a configuration in which:

wherein the center land portion comprises at least one width connecting groove that causes the at least one annular groove and the first main groove to be connected; and

the at least one width connecting groove causes the first main groove and a location at which two groove segments among the plurality of groove segments are mutually contiguous to be connected.

Further, the pneumatic tire may have a configuration in which:

wherein the at least one annular groove is among a plurality thereof that are arrayed along the tire circumferential direction;

the center land portion comprises at least one circumferential connecting groove that causes two of the annular grooves to be mutually connected; and

respective depths of the two of the annular grooves are greater than depth of the at least one circumferential connecting groove.

Further, the pneumatic tire may have a configuration in which:

wherein the at least one annular groove is among a plurality thereof that are arrayed along the tire circumferential direction;

the center land portion comprises at least one circumferential connecting groove that causes two of the annular grooves to be mutually connected; and

a side toward which the at least one circumferential connecting groove is inclined with respect to the tire circumferential direction is opposite a side toward which the at least one longest groove segment at each of the two of the annular grooves are inclined with respect to the tire circumferential direction.

Further, the pneumatic tire may have a configuration in which:

wherein the at least one annular groove is among a plurality thereof that are arrayed along the tire circumferential direction;

the center land portion comprises at least one circumferential connecting groove that causes two of the annular grooves to be mutually connected; and

a side toward which the at least one circumferential connecting groove is inclined with respect to the tire circumferential direction is same as a side toward which the at least one shortest groove segment at each of the two of the annular grooves are inclined with respect to the tire circumferential direction.

Further, the pneumatic tire may have a configuration in which:

wherein the center land portion comprises first and second width connecting grooves that cause the at least one annular groove and the first main groove to be connected; and

a side toward which the first width connecting groove is inclined with respect to the tire circumferential direction is opposite a side toward which the second width connecting groove is inclined with respect to the tire circumferential direction.

Further, the pneumatic tire may have a configuration in which:

wherein length of the first width connecting groove is greater than length of the second width connecting groove; and

the side toward which the first width connecting groove is inclined with respect to the tire circumferential direction is same as a side toward which the at least one shortest groove segment is inclined with respect to the tire circumferential direction.

Further, the pneumatic tire may have a configuration in which:

wherein the at least one annular groove is among a plurality thereof that are arrayed along the tire circumferential direction;

the center land portion comprises at least one circumferential connecting groove that causes two of the annular grooves to be mutually connected; and

the at least one circumferential connecting groove is contiguous with a location separated from a location at which the groove segments at each of the two of the annular grooves are mutually contiguous.

Further, the pneumatic tire may have a configuration in which:

wherein a smallest angle among interior angles formed by mutual intersection of the plurality of groove segments is not less than 40% of a largest angle among interior angles formed by mutual intersection of the plurality of groove segments.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing the principal components at the tread surface of a pneumatic tire associated with same embodiment as they would exist if unwrapped so as to lie in a single plane;

FIG. 3 is a drawing for explaining a first inclined side;

FIG. 4 is a drawing for explaining a second inclined side;

FIG. 5 is an enlarged view of region V in FIG. 2;

FIG. 6 is a drawing for explaining the constitution of the annular groove at FIG. 5;

FIG. 7 is a drawing showing the principal components at the tread surface of a pneumatic tire associated with another embodiment as they would exist if unwrapped so as to lie in a single plane;

FIG. 8 is a drawing for explaining the constitution of the annular groove at FIG. 7; and

FIG. 9 is a table showing results of evaluation of working examples and comparative examples.

### DETAILED DESCRIPTION OF THE INVENTION

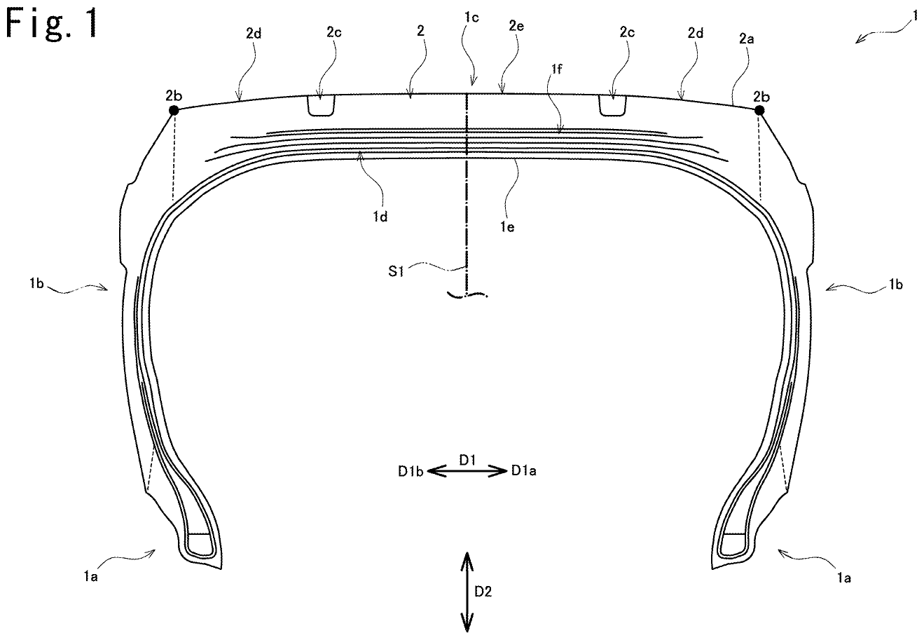

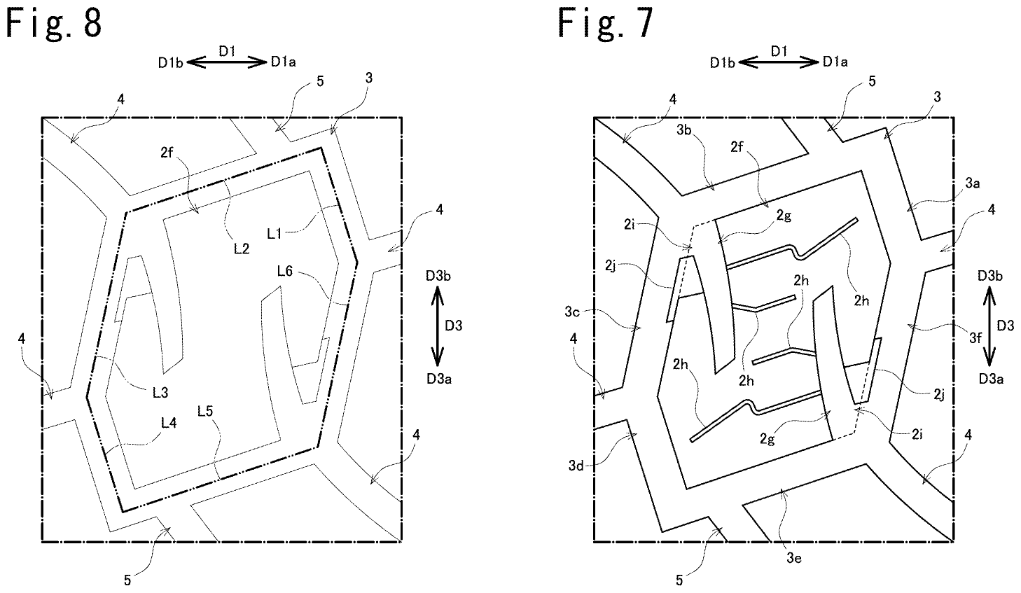

Below, an embodiment of a pneumatic tire is described with reference to FIG. 1 through FIG. 6. At the respective drawings (and the same is true for FIG. 7 and FIG. 8), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

In the tire width direction D1, the side toward the interior is the side which is nearer to tire equatorial plane S1, and the side toward the exterior is the side which is farther from tire equatorial plane S1. Furthermore, in the tire radial direction D2, the side toward the interioris the side which is nearer to the tire rotational axis, and the side toward the exterior is the side which is farther from the tire rotational axis.

The tire width direction D1 may be further subdivided into what will be referred to as a first width direction side D1a toward one side (first side) D1a, and what will be referred to as a second width direction side D1b toward the other side (second side) D1b. Furthermore, the tire circumferential direction D3 may be further subdivided into what will be referred to as a first circumferential direction side D3a toward one side (first side) D3a, and what will be referred to as a second circumferential direction side D3b toward the other side (second side) D3b.

As shown in FIG. 1, tire 1 associated with the present embodiment is provided with a pair of bead regions la at which beads are present; sidewall regions 1b which extend outwardly in the tire radial direction D2 from the respective bead regions 1a; and tread region 1c, the exterior surface in the tire radial direction D2 of which contacts the road surface and which is contiguous with the outer ends in the tire radial direction D2 of the pair of sidewall regions 1b. In accordance with the present embodiment, tire 1 is a pneumatic tire 1, the interior of which is capable of being filled with air, and which is capable of being mounted on a rim (not shown).

Furthermore, tire 1 is provided with carcass layer 1d which spans the pair of beads, and innerliner layer 1e which is arranged at a location toward the interior from carcass layer 1d and which has superior functionality in terms of its ability to impede passage of gas therethrough so as to permit air pressure to be maintained. Carcass layer 1d and innerliner layer 1e are arranged in parallel fashion with respect to the inner circumferential surface of the tire over a portion thereof that encompasses bead regions 1a, sidewall regions 1b, and tread region 1c.

Tread region 1c is provided with tread rubber 2 having tread surface 2a which contacts the road surface, and belt layer 1f which is arranged between tread rubber 2 and carcass layer 1d. Present at tread surface 2a is the contact patch that actually comes in contact with the road surface, and the portions within said contact patch that are present at the outer ends in the tire width direction D1 are referred to as contact patch ends 2b, 2b.

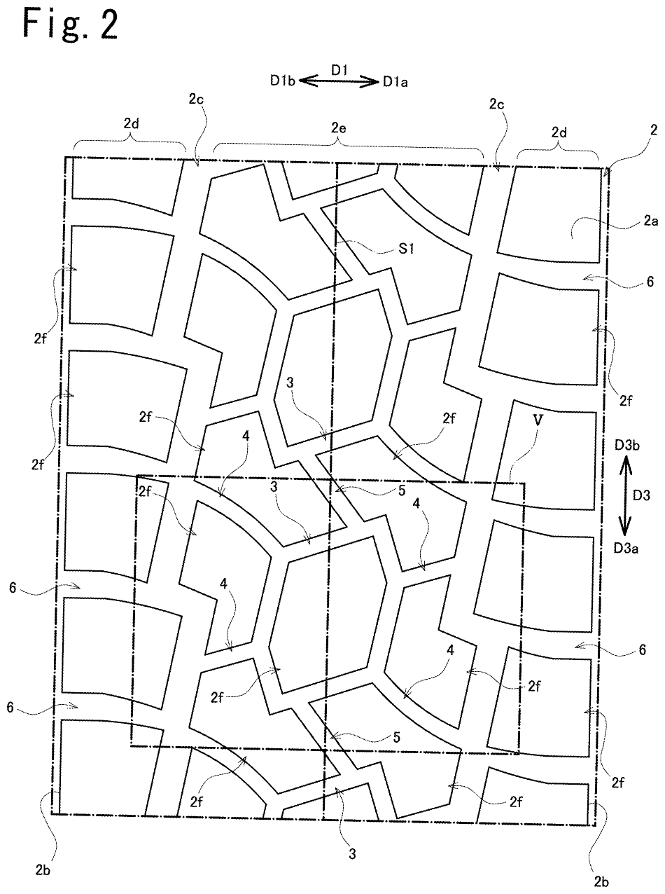

As shown in FIG. 1 and FIG. 2, tread rubber 2 comprises a plurality of main grooves 2c, 2c that extend in the tire circumferential direction D3. Main groove 2c extends continuously along the entire length of tire circumferential direction D3. In addition, the constitution is such that main groove 2c extends in zigzag fashion along the tire circumferential direction D3. Note that a constitution may also be adopted in which main groove 2c extends in parallel fashion with respect to the tire circumferential direction D3.

There is no limitation with respect thereto, it also being possible, for example, to adopt a constitution in which main groove 2c comprises so-called tread wear indicator(s) (not shown) which are portions at which depth of the groove is reduced so as to make it possible to ascertain the extent to which wear has occurred as a result of the exposure thereof that takes place in accompaniment to wear. Furthermore, while there is no particular limitation with respect to the number of main grooves 2c, the number of main grooves 2c that are present in the present embodiment is two.

Furthermore, while there is no particular limitation with respect thereto, it is also possible to adopt a constitution in which, for example, main grooves 2c are each of groove width not less than 3% of the distance (dimension in the tire width direction D1) between contact patch ends 2b, 2b. Furthermore, while there is no particular limitation with respect thereto, it is also possible to adopt a constitution in which, for example, main grooves 2c are each of groove width not less than 5 mm.

Tread rubber 2 comprises a plurality of land portions 2d, 2e that are partitioned by main groove(s) 2c, 2c and contact patch end(s) 2b, 2b. At the plurality of land portions 2d, 2e, land portion(s) 2d which are partitioned by main groove(s) 2c and contact patch end(s) 2b and which are arranged in outwardmost fashion in the tire width direction D1 are referred to as shoulder land portion(s) 2d, and land portion(s) 2e which are partitioned by the main grooves 2c, 2c that are respectively adjacent thereto and which are arranged between pair of shoulder land portions 2d, 2d are referred to as middle land portion(s) 2e.

Among middle land portion(s) 2e, note that those land portion(s) 2e which intersect tire equatorial plane S1 are referred to as center land portion(s) 2e. That is, the pair of main grooves 2c, 2c that partition center land portion(s) 2e are arranged so as to straddle tire equatorial plane S1 in the tire width direction D1 and so as to respectively be separated from tire equatorial plane S1 in the tire width direction D1. Furthermore, while there is no particular limitation with respect to the number of land portions 2d, 2e, because in the present embodiment the number of main grooves 2c that are present is two, the number of land portions 2d, 2e that are present is three, and the number of middle land portions 2e that are present is one.

As shown in FIG. 2, land portions 2d, 2e comprise a plurality of land grooves 3 through 6 extending in at least one of the tire width direction D1 and the tire circumferential direction D3. As a result, land portions 2d, 2e comprise a plurality of blocks 2f that are partitioned by grooves 2c, 3-6. In addition, the plurality of blocks 2f are arrayed along the tire circumferential direction D3. While there is no particular limitation with respect thereto, note that it is also possible to adopt a constitution in which, for example, land grooves 3 through 6 have groove widths not less than 2 mm.

Land grooves 3 through 5 of center land portion(s) 2e comprise annular groove(s) 3 arranged so as to be separated from main groove(s) 2c in the tire width direction D1. Moreover, a plurality of annular grooves 3 are arrayed along the tire circumferential direction D3 in such fashion as to intersect tire equatorial plane S1. Furthermore, land grooves 3 through 5 of center land portion(s) 2e comprise width connecting groove(s) 4 which cause annular groove(s) 3 and main groove(s) 2c to be connected, and circumferential connecting groove(s) 5 which cause annular grooves 3, 3 that are adjacent in the tire circumferential direction D3 to be mutually connected.

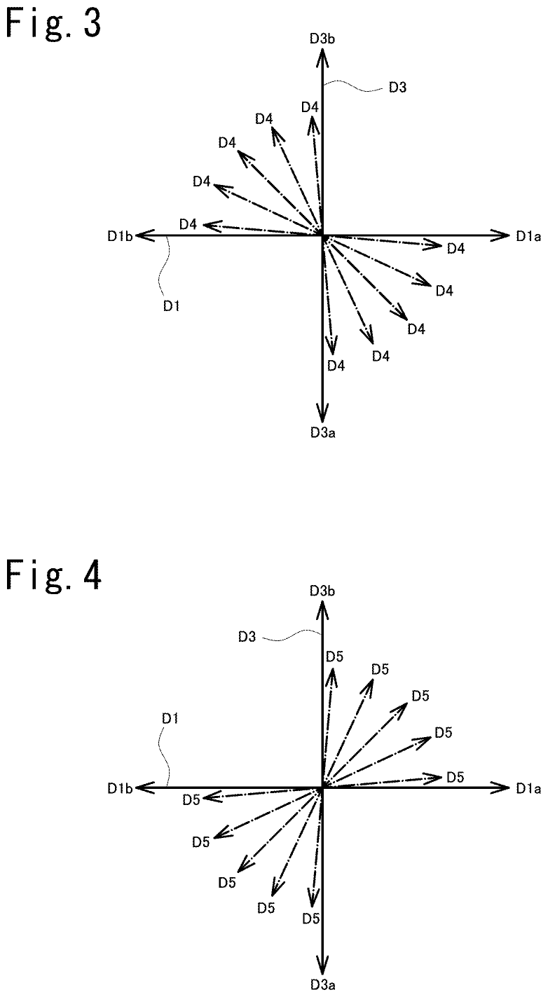

The constitutions of land grooves 3 through 5 at center land portion(s) 2e will now be described with reference to FIG. 3 through FIG. 6.

Note, as shown in FIG. 3, that the side D4 which is inclined in such fashion as to be increasingly directed toward first circumferential direction side D3a as one proceeds toward first width direction side D1a (the side which is inclined in such fashion as to be increasingly directed toward second circumferential direction side D3b as one proceeds toward second width direction side D1b) will be referred to as first inclined side D4. Furthermore, as shown in FIG. 4, the side D5 which is inclined in such fashion as to be increasingly directed toward second circumferential direction side D3b as one proceeds toward first width direction side D1a (the side which is inclined in such fashion as to be increasingly directed toward first circumferential direction side D3a as one proceeds toward second width direction side D1b) will be referred to as second inclined side D5.

In addition, where it is said that the side toward which something is inclined with respect to tire circumferential direction D3 (tire width direction D1) is the same as the side toward which something else is inclined with respect thereto, this means that the two are inclined toward the same side (e.g., first inclined side D4, D4 or second inclined side D5, D5). That is, where it is said that the side toward which something is inclined with respect to tire circumferential direction D3 (tire width direction D1) is the same as the side toward which something else is inclined with respect thereto, this should be understood to include the situation in which the two are inclined toward the same side D4, D4 (D5, D5) notwithstanding the fact that the angles of inclination thereof with respect to tire circumferential direction D3 (tire width direction D1) may be different.

Furthermore, where it is said that the side toward which something is inclined with respect to tire circumferential direction D3 (tire width direction D1) is opposite the side toward which something else is inclined with respect thereto, this means that the two are inclined toward opposite sides (first inclined side D4 and second inclined side D5). That is, where it is said that the side toward which something is inclined with respect to tire circumferential direction D3 (tire width direction D1) is opposite the side toward which something else is inclined with respect thereto, this should be understood to include the situation in which the two are inclined toward opposite sides D4, D5 notwithstanding the fact that the angles of inclination thereof with respect to tire circumferential direction D3 (tire width direction D1) may be the same.

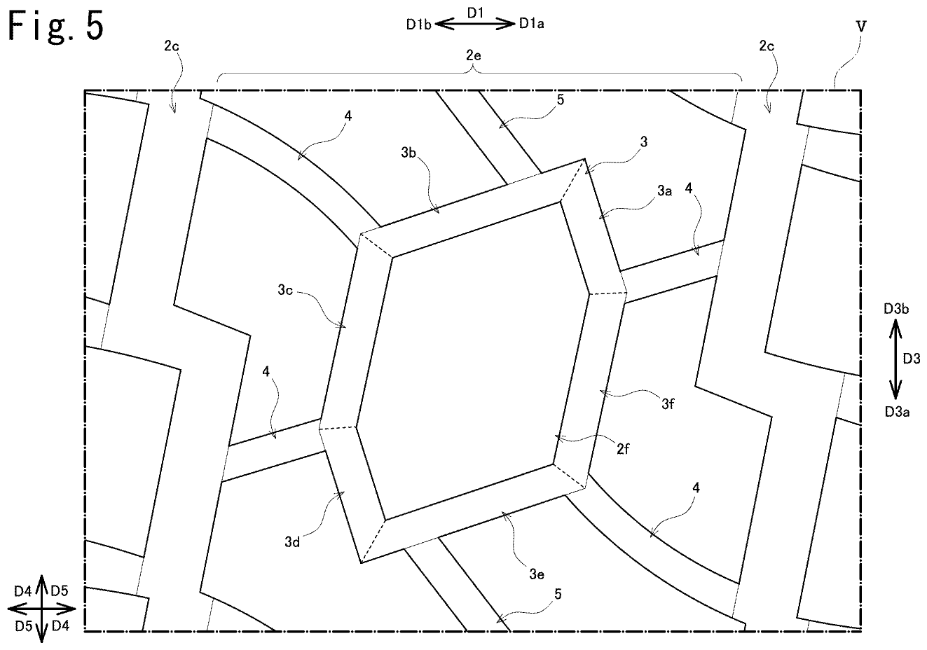

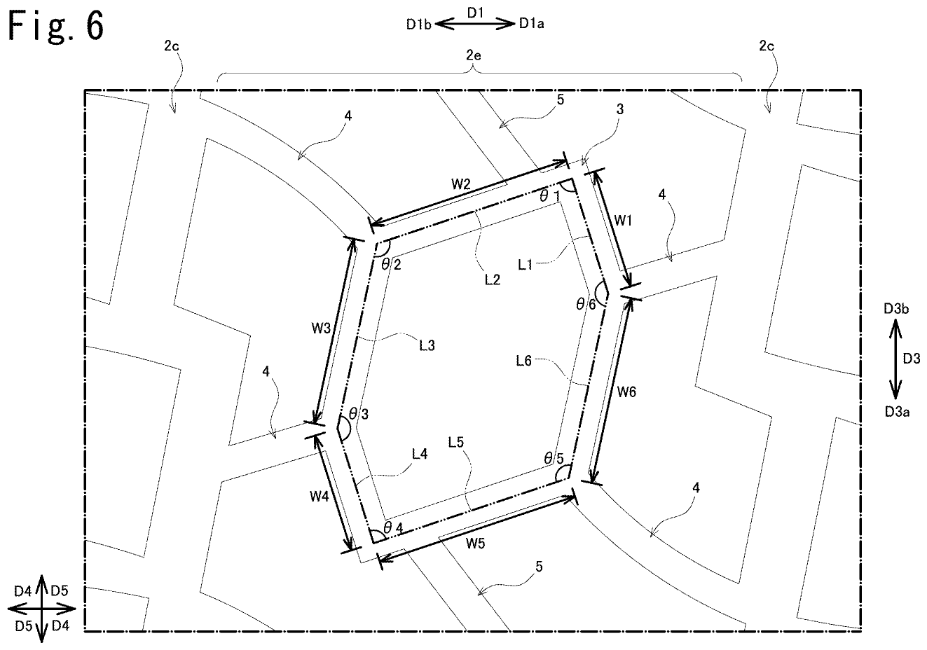

As shown in FIG. 5 and FIG. 6, annular groove 3 comprises a plurality of groove segments 3a through 3f. This causes annular groove 3 to be formed in polygonal and annular fashion. While there is no particular limitation with respect thereto, note that the shape of annular groove 3 in the present embodiment is such that number of groove segments 3a through 3f is six, annular groove 3 being formed in roughly hexagonal and annular fashion.

At FIG. 5, boundaries between respective groove segments 3a through 3f are shown in broken line. Furthermore, at FIG. 6, groove width centerlines L1 through L6 at groove segments 3a through 3f are respectively shown in double-dash chain line. Below, lengths W1 through W6 of groove segments 3a through 3f refer to lengths of centerlines L1 through L6 of groove segments 3a through 3f, and angles θ1 through θ6 formed by mutual intersection of groove segments 3a through 3f (hereinafter also referred to as simply “groove intersection angles”) refer to the angles at which centerlines L1 through L6 of groove segments 3a through 3f mutually intersect.

In accordance with the present embodiment, among the plurality of groove segments 3a through 3f, the shortest groove segments 3a, 3d (those for which length W1 through W6 is smallest) are first and fourth groove segments 3a, 3d, and the longest groove segments 3b, 3e (those for which length W1 through W6 is largest) are second and fifth groove segments 3b, 3e. Furthermore, in accordance with the present embodiment, among the plurality of groove intersection angles θ1 through θ6, the largest angles are third and sixth groove intersection angles θ3, θ6, and the smallest angles are first and fourth groove intersection angles θ1, θ4.

The plurality of annular grooves 3 are arrayed along the tire circumferential direction D3 in such fashion as to intersect tire equatorial plane S1. As a result, when driving straight ahead, because contact patch length (length in the tire circumferential direction D3 where contact is made with the ground) in the central region in the tire width direction D1 will increase, it will be possible to cause a plurality of annular grooves 3 to come in contact with the ground. This will make it possible to increase the number of edge components of annular groove(s) 3 that come in contact with the ground.

In addition, at the plurality of groove segments 3a through 3f, the lengths W1, W4 of first and fourth groove segments 3a, 3d, which are shortest thereamong, are not less than 40% of the lengths W2, W5 of second and fifth groove segments 3b, 3e, which are longest thereamong. As a result, because it will be possible to ensure that lengths of edge components attributable to respective groove segments 3a through 3f are adequate, this will make it possible to adequately cause functionality of edge components attributable to annular groove(s) 3 to be made manifest.

Moreover, it is, for example, preferred that lengths W1, W4 of groove segments 3a, 3d which are shortest thereamong be not less than 45% of lengths W2, W5 of groove segments 3b, 3e which are longest thereamong, more preferred that these be not less than 50% thereof, and extremely preferred that these be not less than 55% thereof. Furthermore, it is, for example, preferred that lengths W1, W4 of groove segments 3a, 3d which are shortest thereamong be not less than 10 mm, and more preferred that these be not less than 15 mm.

Furthermore, the side D5 toward which second and fifth groove segments 3b, 3e which are longest thereamong are inclined with respect to tire circumferential direction D3 is second inclined side D5, and the side D4 toward which first and fourth groove segments 3a, 3d which are shortest thereamong are inclined with respect to tire circumferential direction D3 is first inclined side D4. At the same time, the side D4 toward which circumferential connecting groove 5 is inclined with respect to tire circumferential direction D3 is first inclined side D4.

As a result, the side D4 toward which circumferential connecting groove 5 is inclined with respect to tire circumferential direction D3 is opposite the side D5 toward which groove segments 3b, 3e which are longest thereamong are inclined with respect to tire circumferential direction D3. And yet, the side D5 toward which circumferential connecting groove 5 is inclined with respect to tire circumferential direction D3 is the same as the side D4 toward which groove segments 3a, 3d which are shortest thereamong are inclined with respect to tire circumferential direction D3.

Accordingly, at center land portion(s) 2e, it is possible to cause lengths of edge components respectively inclined toward sides D4, D5 to be made uniform. Note that the side D5 toward which third and sixth groove segments 3c, 3f are inclined with respect to tire circumferential direction D3 is second inclined side D5.

Furthermore, the plurality of width connecting grooves 4 comprise width connecting groove(s) 4 inclined toward first inclined side D4, and width connecting groove(s) 4 inclined toward second inclined side D5. As a result, at center land portion(s) 2e, it is possible to cause lengths of edge components respectively inclined toward sides D4, D5 to be made even more uniform. While there is no particular limitation with respect thereto, note in the present embodiment that two width connecting grooves 4 are provided that are inclined toward first inclined side D4, and two width connecting grooves 4 are provided that are inclined toward second inclined side D5.

Moreover, depths of annular grooves 3 are greater than depths of width connecting grooves 4, and depths of annular grooves 3 are greater than depths of circumferential connecting grooves 5. More specifically, depths of the plurality of groove segments 3a through 3f are greater than depths of width connecting grooves 4, and depths of the plurality of groove segments 3a through 3f are greater than depths of circumferential connecting grooves 5. As a result, it is possible to improve the functionality of edge components attributable to annular grooves 3.

Thus, because it is ensured that lengths and depths of edge components attributable to the respective groove segments 3a through 3f will be adequate, it is possible by means of the edge components of annular grooves 3 to improve tire performance on adverse road surfaces and snowy road surfaces. Moreover, at land grooves 3 through 5 of center land portion 2e, because it is possible to cause lengths of edge components respectively inclined toward sides D4, D5 to be made uniform, it will be possible by means of the edge components of land grooves 3 through 5 at center land portion 2e to effectively improve tire performance on adverse road surfaces and snowy road surfaces.

While there is no limitation with respect thereto, at the plurality of groove intersection angles θ1 through θ6, it so happens that first and fourth groove intersection angles θ1, θ4 which are smallest thereamong are not less than 40% of third and sixth groove intersection angles θ3, θ6 which are largest thereamong. As a result, because angles of corners at block(s) 2f partitioned by annular groove(s) are made uniform, it will be possible to suppress occurrence of variation in rigidity at such block(s) 2f.

Moreover, it is, for example, preferred that groove intersection angles θ1, θ4 which are smallest thereamong be not less than 45% of groove intersection angles θ3, θ6 which are largest thereamong, more preferred that these be not less than 50% thereof, and extremely preferred that these be not less than 55% thereof. Furthermore, it is, for example, preferred that groove intersection angles θ1, θ4 which are smallest thereamong be not less than 70°, and more preferred that these be not less than 80°. Furthermore, it is, for example, preferred that groove intersection angles θ3, θ6 which are largest thereamong be not greater than 170°, and more preferred that these be not greater than 160°.

Furthermore, width connecting grooves 4 cause main grooves 2c and locations at which groove segments 3a through 3f are mutually contiguous to be connected. More specifically, first ends of width connecting grooves 4 are contiguous with locations at boundaries (shown in broken line in FIG. 5) between groove segments 3a through 3f, and second ends of width connecting grooves 4 are contiguous with main grooves 2c. Because this makes it possible for water to be shed in such fashion as to be directed from respective groove segments 3a through 3f toward main grooves 2c, this makes it possible to improve water shedding performance.

Furthermore, circumferential connecting grooves 5 cause an intermediate location at groove segment 3b of one annular groove 3 and an intermediate location at groove segment 3e of another annular groove 3 to be connected. More specifically, a first end of circumferential connecting groove 5 is contiguous with a location separated from the ends of groove segment 3b of one annular groove 3, and a second end of circumferential connecting groove 5 is contiguous with a location separated from the ends of groove segment 3e of another annular groove 3.

That is, respective ends of circumferential connecting grooves 5 are contiguous with locations separated from boundaries (shown in broken line in FIG. 5) between groove segments 3a through 3f. This causes shapes of grooves formed by circumferential connecting grooves 5 and annular grooves 3 to be zigzag-shaped. Accordingly, because it is for example possible to disrupt flow of air within grooves, this makes it possible to reduce occurrence of sound attributable to air column resonance.

As described above, the pneumatic tire 1 of the embodiment includes:

first and second main grooves 2c, 2c extending in a tire circumferential direction D3 and arranged so as to straddle a tire equatorial plane S1, and a center land portion 2e partitioned by the first and second main grooves 2c, 2c;

wherein the center land portion 2e comprises at least one annular groove 3 arranged so as to be separated in a tire width direction D1 from the first and second main grooves 2c, 2c and so as to intersect the tire equatorial plane S1;

wherein the at least one annular groove 3 comprises a plurality of groove segments 3a through 3f that cause the at least one annular groove 3 to be of polygonal and annular shape;

wherein the plurality of groove segments 3a through 3f includes at least one shortest groove segment 3a, 3d for which length is smallest among the plurality of groove segments 3a through 3f, and at least one longest groove segment 3b, 3e for which length is largest among the plurality of groove segments 3a through 3f; and

wherein the length W1, W4 of the shortest groove segment 3a, 3d is not less than 40% of the length W2, W5 of the longest groove segment 3b, 3e.

In accordance with such constitution, because annular groove 3 comprises a plurality of groove segments 3a through 3f, annular groove 3 is formed in polygonal and annular fashion. In addition, at the plurality of groove segments 3a through 3f, because lengths W1, W4 of groove segments 3a, 3d, which are shortest thereamong are not less than 40% of lengths W2, W5 of groove segments 3b, 3e which are longest thereamong, it is possible to ensure that lengths of edge components attributable to respective groove segments 3a through 3f are adequate. As a result, it will be possible to adequately cause functionality of edge components attributable to annular grooves 3 to be made manifest.

Further, in the pneumatic tire 1 of the embodiment,

wherein the center land portion 2e comprises at least one width connecting groove 4 that causes the at least one annular groove 3 and the first main groove 2c to be connected; and

depth of the at least one annular groove 3 is greater than depth of the at least one width connecting groove 4.

In accordance with such constitution, because depths of annular grooves 3 are greater than depths of width connecting grooves 4, it is possible to improve functionality of edge components attributable to annular grooves 3. As a result, it is possible to effectively cause functionality of edge components attributable to annular grooves 3 to be made manifest.

Further, in the pneumatic tire 1 of the embodiment,

wherein the center land portion 2e comprises at least one width connecting groove 4 that causes the at least one annular groove 3 and the first main groove 2c to be connected; and

the at least one width connecting groove 4 causes the first main groove 2c and a location at which two groove segments 3a and 3f (3b and 3c, 3c and 3d, 3e and 3f)among the plurality of groove segments 3a through 3f are mutually contiguous to be connected.

In accordance with such constitution, width connecting grooves 4 cause main grooves 2c and locations at which groove segments 3a through 3f of annular groove 3 are mutually contiguous to be connected. As a result, because respective groove segments 3a through 3f are connected to main grooves 2c by means of width connecting grooves 4, this makes it possible for water to be shed in such fashion as to be directed from respective groove segments 3a through 3f toward main grooves 2c.

Further, in the pneumatic tire 1 of the embodiment,
wherein the at least one annular groove 3 is among a plurality thereof that are arrayed along the tire circumferential direction D3;

the center land portion 2e comprises at least one circumferential connecting groove 5 that causes two of the annular grooves 3 and 3 to be mutually connected; and

respective depths of the two of the annular grooves 3 and 3 are greater than depth of the at least one circumferential connecting groove 5.

In accordance with such constitution, because depths of annular grooves 3 are greater than depths of circumferential connecting grooves 5, it is possible to improve functionality of edge components attributable to annular grooves 3. As a result, it is possible to effectively cause functionality of edge components attributable to annular grooves 3 to be made manifest.

Further, in the pneumatic tire 1 of the embodiment, wherein the at least one annular groove 3 is among a plurality thereof that are arrayed along the tire circumferential direction D3;

the center land portion 2e comprises at least one circumferential connecting groove 5 that causes two of the annular grooves 3 and 3 to be mutually connected; and a side D4 toward which the at least one circumferential connecting groove 5 is inclined with respect to the tire circumferential direction D3 is opposite a side D5 toward which the at least one longest groove segment 3b, 3e at each of the two of the annular grooves 3 and 3 are inclined with respect to the tire circumferential direction D3.

In accordance with such constitution, because the side D4 toward which circumferential connecting groove 5 is inclined with respect to tire circumferential direction D3 is opposite the side D5 toward which groove segments 3b, 3e which are longest thereamong are inclined with respect to tire circumferential direction D3, it is possible to cause lengths of edge components respectively inclined toward sides D4, D5 to be made uniform. As a result, it is possible to effectively cause functionality of edge components attributable to annular grooves 3 to be made manifest.

Further, in the pneumatic tire 1 of the embodiment, wherein the at least one annular groove 3 is among a plurality thereof that are arrayed along the tire circumferential direction D3;

the center land portion 2e comprises at least one circumferential connecting groove 5 that causes two of the annular grooves 3 and 3 to be mutually connected; and a side D4 toward which the at least one circumferential connecting groove 5 is inclined with respect to the tire circumferential direction D3 is same as a side D4 toward which the at least one shortest groove segment 3a, 3d at each of the two of the annular grooves 3 and 3 are inclined with respect to the tire circumferential direction D3.

In accordance with such constitution, because the side D4 toward which circumferential connecting groove 5 is inclined with respect to tire circumferential direction D3 is the same as the side D4 toward which groove segments 3a, 3d which are shortest thereamong are inclined with respect to tire circumferential direction D3, it is possible to cause lengths of edge components respectively inclined toward sides D4, D5 to be made uniform. As a result, it is possible to effectively cause functionality of edge components attributable to annular grooves 3 to be made manifest.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) For example as shown in FIG. 7, it is also possible to adopt a constitution in which block 2f formed by annular groove 3 comprises at least one of block groove(s) 2g and sipe(s) 2h. Note, for example, that block groove 2g refers to a recess of width not less than 1.6 mm, and sipe 2h refers to a recess of width less than 1.6 mm.

Furthermore, for example as shown in FIG. 7, it is also possible to adopt a constitution in which block 2f formed by annular groove 3 comprises notch portion(s) 2i. At FIG. 7, note that notch portion 2i is contiguous with block groove 2g. Furthermore, for example as shown in FIG. 7, it is also possible to adopt a constitution in which land portion 2e comprises reinforcing portion(s) 2j which are arranged toward the interior from annular groove 3 and which are contiguous with block 2f.

At FIG. 7, imaginary lines which are extensions of edges of annular groove 3 (more specifically, groove segments 3b, 3c, 3e, 3f) are shown in broken line. In addition, as shown for example in FIG. 8, in a situation in which at least one of block groove(s) 2g and notch portion(s) 2i are provided, groove width centerlines L1 through L6 at groove segments 3a through 3f are defined based on imaginary lines which are extensions of edges of annular groove 3.

(2) Furthermore, the constitution of pneumatic tire 1 associated with the foregoing embodiment is such that annular grooves 3 are arranged in continuous fashion in the tire circumferential direction D3 with circumferential connecting grooves 5 interposed therebetween. However, pneumatic tire 1 is not limited to such constitution. For example, it is also possible to adopt a constitution in which, for example, annular grooves 3 are arranged in intermittent fashion in the tire circumferential direction D3, and it is also possible to adopt a constitution in which, for example, only a single annular groove 3 is provided at center land portion 2e. Note that it is preferred that annular groove(s) 3 be arranged in such fashion that at least one thereof will definitely make contact with the ground.

(3) Furthermore, the constitution of pneumatic tire 1 associated with the foregoing embodiment is such that depths of annular grooves 3 are greater than depths of width connecting grooves 4. However, pneumatic tire 1 is not limited to such constitution. For example, it is also possible to adopt a constitution in which depths of annular grooves 3 are less than depths of width connecting grooves 4. In accordance with such constitution, not only will it be possible to increase rigidity of blocks 2f partitioned by annular grooves 3 but it will also be possible to improve water shedding capability of width connecting grooves 4. Furthermore, it is also possible, for example, to adopt a constitution in which depths of annular grooves 3 are the same as depths of width connecting grooves 4.

(4) Furthermore, the constitution of pneumatic tire 1 associated with the foregoing embodiment is such that depths of annular grooves 3 are greater than depths of circumferential connecting grooves 5. However, pneumatic tire 1 is not limited to such constitution. For example, it is also possible to adopt a constitution in which depths of annular grooves 3 are less than depths of circumferential connecting grooves 5. Furthermore, it is also possible, for example, to adopt a constitution in which depths of annular grooves 3 are the same as depths of circumferential connecting grooves 5.

(5) Furthermore, the constitution of pneumatic tire 1 associated with the foregoing embodiment is such that center land portion 2e comprises width connecting grooves 4 which cause annular grooves 3 and main grooves 2c to be connected, and circumferential connecting grooves 5 which cause annular grooves 3, 3 to be mutually connected. However, pneumatic tire 1 is not limited to such constitution. For example, it is also possible to adopt a constitution in which center land portion 2e does not comprise at least one of width connecting groove(s) 4 and circumferential connecting groove(s) 5.

(6) Furthermore, the constitution of pneumatic tire 1 associated with the foregoing embodiment is such that width connecting grooves 4 cause main grooves 2c and locations at which groove segments 3a through 3f are mutually contiguous to be connected. However, pneumatic tire 1 is not limited to such constitution. For example, it is also possible to adopt a constitution in which width connecting grooves 4 cause main grooves 2c and intermediate locations at groove segments 3a through 3f (locations separated from ends of groove segments 3a through 3f) to be connected.

(7) Furthermore, the constitution of pneumatic tire 1 associated with the foregoing embodiment is such that circumferential connecting grooves 5 cause an intermediate location at groove segment 3b of one annular groove 3 and an intermediate location at groove segment 3e of another annular groove 3 to be connected. However, pneumatic tire 1 is not limited to such constitution. For example, it is also possible to adopt a constitution in which at least one end of circumferential connecting grooves 5 are contiguous with locations at which groove segments 3a through 3f are mutually contiguous.

(8) Furthermore, the constitution of pneumatic tire 1 associated with the foregoing embodiment is such that the side D4 toward which circumferential connecting groove 5 is inclined with respect to tire circumferential direction D3 is opposite the side D5 toward which groove segments 3b, 3e which are longest thereamong are inclined with respect to tire circumferential direction D3. However, pneumatic tire 1 is not limited to such constitution. For example, it is also possible to adopt a constitution in which the side D4, D5 toward which circumferential connecting groove 5 is inclined with respect to tire circumferential direction D3 is the same as the side D4, D5 toward which groove segments 3b, 3e which are longest thereamong are inclined with respect to tire circumferential direction D3.

(9) Furthermore, the constitution of pneumatic tire 1 associated with the foregoing embodiment is such that the side D4 toward which circumferential connecting groove 5 is inclined with respect to tire circumferential direction D3 is the same as the side D4 toward which groove segments 3a, 3d which are shortest thereamong are inclined with respect to tire circumferential direction D3. However, pneumatic tire 1 is not limited to such constitution. For example, it is also possible to adopt a constitution in which the side D4, D5 toward which circumferential connecting groove 5 is inclined with respect to tire circumferential direction D3 is opposite the side D5, D4 toward which groove segments 3a, 3d which are shortest thereamong are inclined with respect to tire circumferential direction D3.

(10) Furthermore, the constitution of pneumatic tire 1 associated with the foregoing embodiment is such that all land portions 2d, 2e are of block-like shape inasmuch as subdivision in the tire circumferential direction D3 by land grooves 3 through 6 causes blocks 2f to be arrayed along the tire circumferential direction D3. However, pneumatic tire 1 is not limited to such constitution. For example, it is also possible to adopt a constitution in which at least one among the plurality of land portions 2d, 2e is of rib-like shape, being continuous in the tire circumferential direction D3.

(11) Furthermore, there is no particular limitation with respect to the road surface on which pneumatic tire 1 may be used. Pneumatic tire 1 may, for example, be used when driving on snowy road surfaces; or may, for example, be used when driving on adverse road surfaces (e.g., in muddy terrain or rocky terrain); or may, for example, be used when driving on dry road surfaces; or may, for example, be used when driving on wet road surfaces.

### EXAMPLES

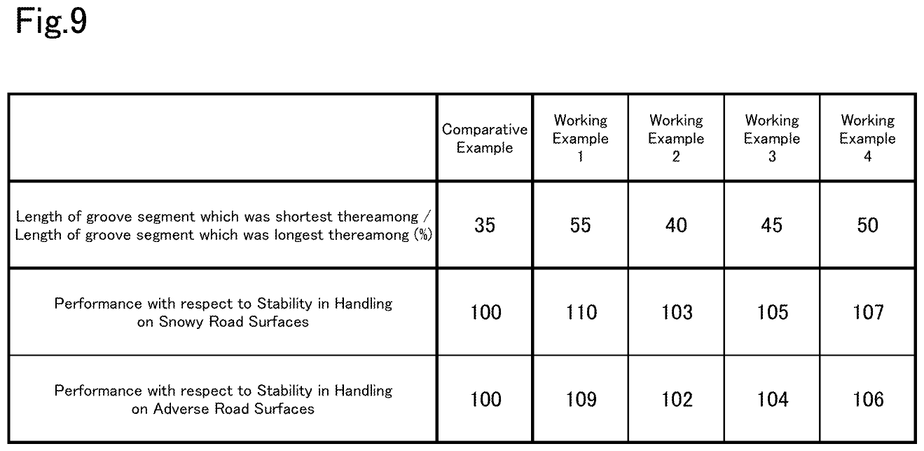

To illustrate the constitution and effect of tire 1 in specific terms, working examples of tire 1 as well as comparative examples thereof are described below with reference to FIG. 9.

<Performance with Respect to Stability in Handling on Snowy Road Surfaces>

Respective tires of size 265/70R17 and internal pressure 240 kPa were mounted on a vehicle (type of vehicle: SUV) and this was driven on a snowy road surface, sensory tests carried out by the driver being employed for the purpose of evaluating performance with respect to stability in handling. Results of evaluation are shown as indexed relative to a value of 100 for the Comparative Example, the larger the index the better the performance with respect to stability in handling on snowy road surfaces.

<Performance with Respect to Stability in Handling on Adverse Road Surfaces>

Respective tires of size 265/70R17 and internal pressure 240 kPa were mounted on a vehicle (type of vehicle: SUV) and this was driven on an adverse road surface (muddy terrain), sensory tests carried out by the driver being employed for the purpose of evaluating performance with respect to stability in handling. Results of evaluation are shown as indexed relative to a value of 100 for the Comparative Example, the larger the index the better the performance with respect to stability in handling on adverse road surfaces.

### Working Example 1

Working Example 1 was the tire 1 associated with the foregoing embodiment associated with FIG. 2 and FIG. 5. More specifically, at annular grooves 3, lengths W1, W4 of groove segments 3a, 3d which were shortest thereamong were 55% of lengths W2, W5 of groove segments 3b, 3e which were longest thereamong.

### Working Examples 2 through 4

Working Example 2 was similar to the tire associated with Working Example 1 except that lengths W1, W4 of groove segments 3a, 3d which were shortest thereamong were 40% of lengths W2, W5 of groove segments 3b, 3e which were longest thereamong.

Working Example 3 was similar to the tire associated with Working Example 1 except that lengths W1, W4 of groove segments 3a, 3d which were shortest thereamong were 45% of lengths W2, W5 of groove segments 3b, 3e which were longest thereamong.

Working Example 4 was similar to the tire associated with Working Example 1 except that lengths W1, W4 of groove segments 3a, 3d which were shortest thereamong were 50% of lengths W2, W5 of groove segments 3b, 3e which were longest thereamong.

### COMPARATIVE EXAMPLE

The comparative example was similar to the tire associated with Working Example 1 except that lengths W1, W4 of groove segments 3a, 3d which were shortest thereamong were 35% of lengths W2, W5 of groove segments 3b, 3e which were longest thereamong.

<Results of Evaluation>

As shown in FIG. 9, as compared with the Comparative Example, Working Examples 1 through 4 permitted improvement in performance with respect to stability in handling on snowy road surfaces and in performance with respect to stability in handling on adverse road surfaces. Thus, causing lengths W1, W4 of groove segments 3a, 3d which were shortest thereamong to be not less than 40% of lengths W2, W5 of groove segments 3b, 3e which were longest thereamong made it possible to adequately cause functionality of edge components attributable to annular grooves 3 to be made manifest.

Furthermore, a more preferred working example of tire 1 is described below.

Performance with respect to stability in handling on snowy road surfaces and performance with respect to stability in handling on adverse road surfaces were superior in the order: Working Example 1, Working Example 4, Working Example 3, Working Example 2. Based on the foregoing, it is preferred that lengths W1, W4 of groove segments 3a, 3d which are shortest thereamong be not less than 45% of lengths W2, W5 of groove segments 3b, 3e which are longest thereamong, more preferred that these be not less than 50% thereof, and extremely preferred that these be not less than 55% thereof.

1. A pneumatic tire comprising:
first and second main grooves extending in a tire circumferential direction and arranged so as to straddle a tire equatorial plane, and a center land portion partitioned by the first and second main grooves;
wherein the center land portion comprises at least one annular groove arranged so as to be separated in a tire width direction from the first and second main grooves and so as to intersect the tire equatorial plane;
wherein the at least one annular groove comprises a plurality of groove segments that cause the at least one annular groove to be of polygonal and annular shape;
wherein the plurality of groove segments includes at least one shortest groove segment for which length is smallest among the plurality of groove segments, and at least one longest groove segment for which length is largest among the plurality of groove segments; and
wherein the length of the shortest groove segment is not less than 40% of the length of the longest groove segment.

2. The pneumatic tire according to claim 1
wherein the center land portion comprises at least one width connecting groove that causes the at least one annular groove and the first main groove to be connected; and
depth of the at least one annular groove is greater than depth of the at least one width connecting groove.

3. The pneumatic tire according to claim 1
wherein the center land portion comprises at least one width connecting groove that causes the at least one annular groove and the first main groove to be connected; and
the at least one width connecting groove causes the first main groove and a location at which two groove segments among the plurality of groove segments are mutually contiguous to be connected.

4. The pneumatic tire according to claim 1
wherein the at least one annular groove is among a plurality thereof that are arrayed along the tire circumferential direction;
the center land portion comprises at least one circumferential connecting groove that causes two of the annular grooves to be mutually connected; and
respective depths of the two of the annular grooves are greater than depth of the at least one circumferential connecting groove.

5. The pneumatic tire according to claim 1
wherein the at least one annular groove is among a plurality thereof that are arrayed along the tire circumferential direction;
the center land portion comprises at least one circumferential connecting groove that causes two of the annular grooves to be mutually connected; and
a side toward which the at least one circumferential connecting groove is inclined with respect to the tire circumferential direction is opposite a side toward which the at least one longest groove segment at each of the two of the annular grooves are inclined with respect to the tire circumferential direction.

6. The pneumatic tire according to claim 1
wherein the at least one annular groove is among a plurality thereof that are arrayed along the tire circumferential direction;
the center land portion comprises at least one circumferential connecting groove that causes two of the annular grooves to be mutually connected; and
a side toward which the at least one circumferential connecting groove is inclined with respect to the tire circumferential direction is same as a side toward which the at least one shortest groove segment at each of the two of the annular grooves are inclined with respect to the tire circumferential direction.

7. The pneumatic tire according to claim 1
wherein the center land portion comprises first and second width connecting grooves that cause the at least one annular groove and the first main groove to be connected; and
a side toward which the first width connecting groove is inclined with respect to the tire circumferential direction is opposite a side toward which the second width connecting groove is inclined with respect to the tire circumferential direction.

8. The pneumatic tire according to claim 7
wherein length of the first width connecting groove is greater than length of the second width connecting groove; and
the side toward which the first width connecting groove is inclined with respect to the tire circumferential direction is same as a side toward which the at least one shortest groove segment is inclined with respect to the tire circumferential direction.

9. The pneumatic tire according to claim 1
wherein the at least one annular groove is among a plurality thereof that are arrayed along the tire circumferential direction;
the center land portion comprises at least one circumferential connecting groove that causes two of the annular grooves to be mutually connected; and
the at least one circumferential connecting groove is contiguous with a location separated from a location at which the groove segments at each of the two of the annular grooves are mutually contiguous.

10. The pneumatic tire according to claim 1
wherein a smallest angle among interior angles formed by mutual intersection of the plurality of groove segments is not less than 40% of a largest angle among interior angles formed by mutual intersection of the plurality of groove segments.
